(19) United States
(12) Patent Application Publication
(10) Pub. No.: US 2022/0205832 A1
(43) Pub. Date: Jun. 30, 2022

(54) AN ENHANCED WEIGHT CALCULATING UTENSIL

(71) Applicants: Raphael GAL, Even Yehuda (IL); Shlomo ZINGLER, Herzelia (IL)

(72) Inventors: Raphael GAL, Even Yehuda (IL); Shlomo ZINGLER, Herzelia (IL)

(21) Appl. No.: 17/609,949

(22) PCT Filed: May 14, 2020
(86) PCT No.: PCT/IL2020/050529

§ 371 Date: Nov. 9, 2021

(30) Foreign Application Priority Data
May 16, 2019 (IL) 266702

(51) Int. Cl. G01G 19/56

(52) U.S. Cl. CPC G01G 19/56

(57) ABSTRACT

An apparatus comprising a force and orientation measuring sensors, and a calculating module.

Said calculating module comprising a processing unit, a memory, and a code designed to calculate the accurate weight of the content of a utensil while held in any angle and orientation or rest upon any surface.

### TECHNICAL FIELD

The present invention pertains to the art of utensils and, more particularly, to scoops, spoons, food catchers and other utensils to be used with bulk or unpacked commodities, goods or foods, and even more specifically of a weighing utensil designed to provide an accurate weight measurement of the contents of said utensil.

### BACKGROUND ART

It is well known in many industries and trades that, when a utensil is used to lift or pick a portion or a certain amount from bulk products or materials such as commodities, food, chemical substances or other ingredients, there must be a way to determine the exact weight or other measured control of said utensil content. The reasons for this could be commercial, that is the consumer should neither overpay nor underpays or the need for an exact amount such as in cooking recipes, pharmaceutical compounds, etc. The problem is more acute where the ingredient to be measured is not of a countable nature or consist of items that are of a non-uniform size or shape.

The obvious solution to this problem is weighing the content of the utensil after been picked up, either with the utensil or without it. This method is, naturally, time-consuming and is not convenient when the Ingredient is not in the vicinity of the weighing scale or when it needs to be cut off, or otherwise gathered.

Those skilled in the art are trying for decades to develop a weighing utensil to allow the exact measurement of its content, some of this invention are detailed herein.

US412049A discloses a combination, in an automatic weighing-scoop, of the scoop, the handle, the dial thereon, a spring by which the scoop is suspended on the handle, with a helical shaft having a hand, and with an arm on the scoopengaging with the helical shaft.

US578642A describes a weighing scoop having a rigid beam projecting rearwardly therefrom, of a hollow tubular handle through which said beam extends longitudinally and upon the rear closed end of which it is pivotally mounted, a case supported by the front end of the handle and interiorly in communication therewith, the rear side of said case having a dial traversed by a pointer and covered by a transparent protein g medium, yielding devices for normally holding the scoop in its elevated position, and connections between the beam and said pointer whereby the depression of the latter is indicated upon the dial, substantially as specified.

US541891A discloses a scoop having a body portion, an upper wall for the same, a suitable handle, a grooved depression in said wall in continuation of the general direction of the handle, a terminal, wall for said groove at one end, and an abutting wall at the opposite end located in the path of the handle, a weighing scale pivoted at the terminal wall, and adapted to be folded into said groove and locked against movement against the abutting wall, substantially

CN202122513U is a utility mode: of a 4The utility model relates to a weighing scoop which mainly comprises a scoop body and a scoophandle, wherein a weighing sensor is mounted on the bottom surface of the scoop body, the weighing sensor is connected with an A/D (analog/digital) conversion circuit, and the A/D conversion circuit s connected with a microprocessor; the input end of the microprocessor is connected with a button, and the output end of the microprocessor is connected with a display screen; the A/D conversion circuit and the microprocessor are mounted in the scoop handle; and the button and the display screen are mounted on the surface at the tail end of the scoop handle.

The weighing sensor comprises a suspension girder type sensor and a bridge type sensor.

US807334A discloses the combination of a receptacle, a handle-support therefor, a pair of parallel links on each side of the receptacle connected therewith at their front ends and with the handle-support at their rear ends, the receptacle provided with a compartment enclosing said handle-support, and a spring engaging the receptacle with said support and located in said compartment.

The problem inherent in all said inventions is that the measurement of weight by any means, mechanical, analog, digital or other, requires the utensil to be completely leveled with the ground. Since weight by definition is power applied perpendicular to the ground.

Some invention tried to solve this problem with a level indication. Such patents are U.S. Pat. No. 6,236,001B1 and U.S. Pat. No. 4,460,054, both suggesting an indication mechanism to alert the handler when the orientation of the scoop Is not leveled with the ground anti requires the manual leveling of the scoop in order to maintain an accurate weighing effect. Said patents disclose as follows:

U.S. 6236001B1 describes a scoop has a handle attached thereto by a neck. The neck has a built-in strain gauge supporting the scoop which measures weight in the scoop.

An analog-digital converter converts the strain gauge output to a digital signal, which displays the weight as a readout (either metric or avoirdupois) on a panel in the handle. Control switches built into the handle or panel control the functions of the scoop, while indicator/annunciator lights indicate status. A level indicator Is provided having a ball bearing resting freely on a conducting bottom plate forming a spherical sector of a predetermined angle and a cylindrical sidewall having therein conducting elements. When the ball bearing contacts a sidewall conducting element it closes a circuit which switches off a level indicator/annunciator light, which when on shows that the scoop is level.

U.S. Pat. No. 4,460,054 discloses a weighing scoop designed for a rapidly repeated packaging of fast food portions. The scoop is being used as a dynamic weighing device. The effects of acceleration on the signal from the load cell or other weight detecting device may be electrically filtered, damped or clipped. This patent aims for tackling the problem of a rapid movement during scaling, and although mention the problem of tilt of the scoop, doesn't really provide a way to overcome this problem. It mentions the possibility of adding or reducing the signal from a load cell, yet as will be explained hereinafter the effect of the orientation of the utensils on the output of a weighing sensor involve a formula that is of a multiplying and differential mathematics nature, therefore, it cannot be solved by means of

Both inventions suggest that the scoop alerts the holder of not being leveled with the ground, and allows to correct the posture of the scoop hence its' orientation.

Yet, although said U.S. Pat. No. 4,460,054 suggests to eliminate the inaccuracies resulting from tilting the scoop during weighing it: doesn't teach how to do it, and in fact cannot do it by way of filtering or amplifying sensors output as described therein by way of electrically elimination.

### SUMMARY OF THE INVENTION

It is an object of the present invention to provide an apparatus that allows the accurate weighing of a content of a utensil while said content is being loaded to said utensil.

It is a further object of the present invention to provide an apparatus that allows calculating the actual weight of a content of a utensil while said content is being loaded to said utensil.

It is yet another object of the present invention to provide an apparatus that allows calculating the accurate weight of a content of a utensil while said utensil is not leveled.

It is another object of the present invention to provide an apparatus that allows calculating the accurate weight of a content of a utensil while said utensil is in direct contact with another object (e.g. a pile of bulk products, a sack od commodities, a turning skewer, etc.).

It is another object of the present invention to provide an apparatus that allows calculating the accurate weight of a content of a utensil while said utensil is not held but rather lay on a surface.

The Present invention provides for an apparatus comprising a force and orientation measuring sensors, and a calculating module.

Said calculating module (8) comprising a processing unit, a memory, and a code designed to calculate the accurate weight of the content of a utensil.

The present invention also provides for an apparatus comprising a product containing member and a touchable member. Wherein said product containing member is designed to allow putting a material in or on it, and is connected to said touchable member (1) in a manner that allows to measure the movement between said product containing member and said touchable member (1) or the related position thereof in a manner that predict the power or the weight said product containing member applies towards the ground.

### BRIEF DESCRIPTION OF THE DRAWINGS

FIG. 1 depict the problem of inaccurate measurement by a utensil of the prior art.

FIG. 2 describes examples of utensils that could be adjusted with accordance to the present invention.

FIG. 3 Represent a utensil in various orientations affecting the read of a weighing sensor.

FIG. 4 Depict an example of a utensil with accordance of the present invention.

FIG. 5 Depict another embodiment of the present invention.

FIG. 6 describes a utensil with accordance to the present invention, where the touchable member (1) is in a form of two spikes alongside the bottom of the content collecting member (2) slightly exceeding it.

FIG. 7 describes a utensil with accordance to the present invention, where the touchable member (1) is a handle on side of the content collecting member (2), and stretching in a form of flat surface under the bottom of the content collecting member (2) slightly exceeding it.

FIG. 8 depict a utensil similar to the previous comprising a different location and possibly different type of the weighing means.

FIG. 9-10 depict yet other embodiment and utensils of the present invention.

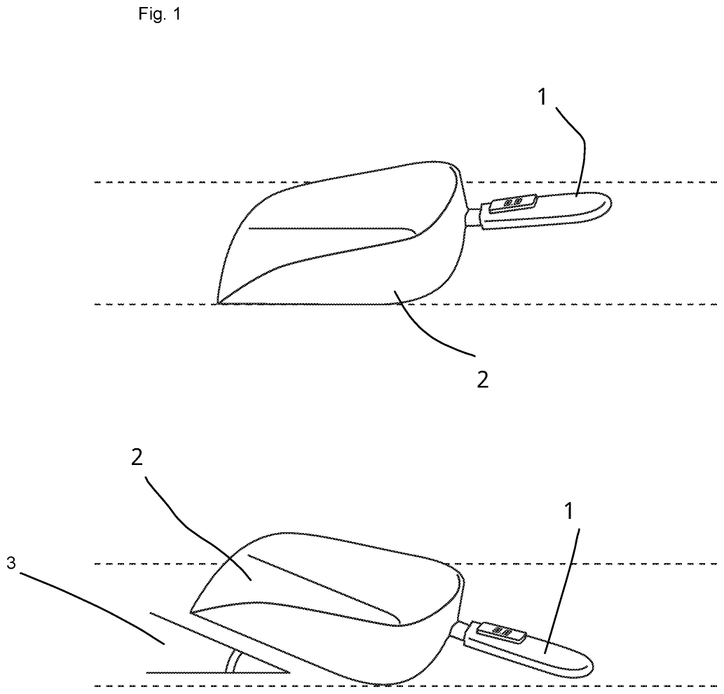

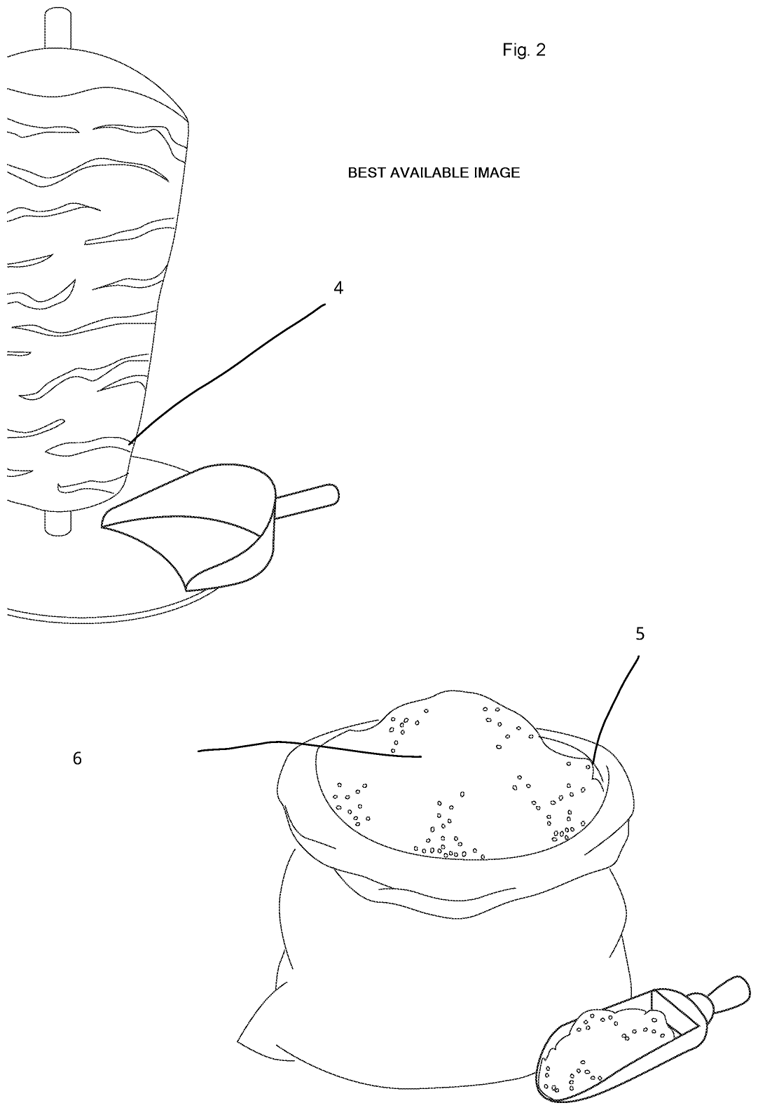

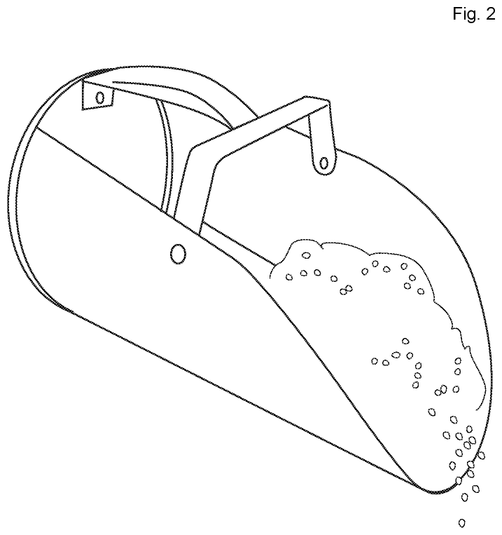

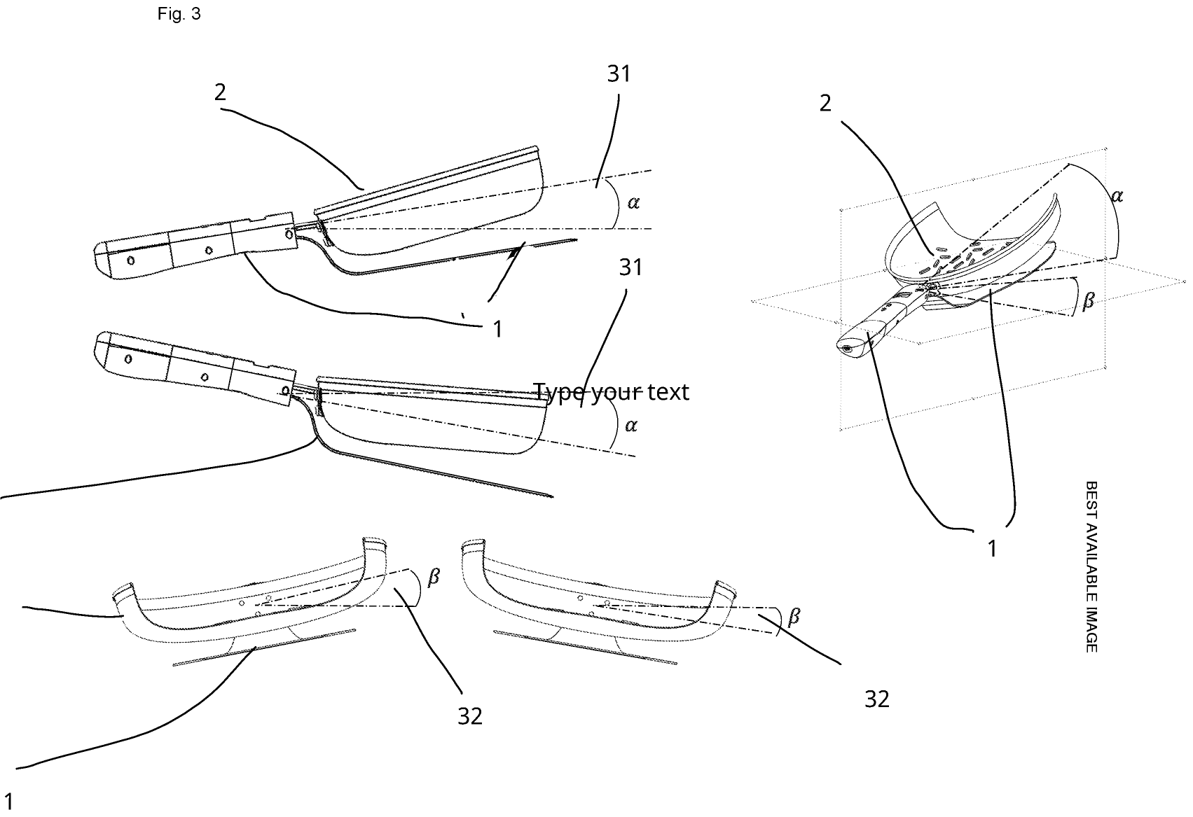

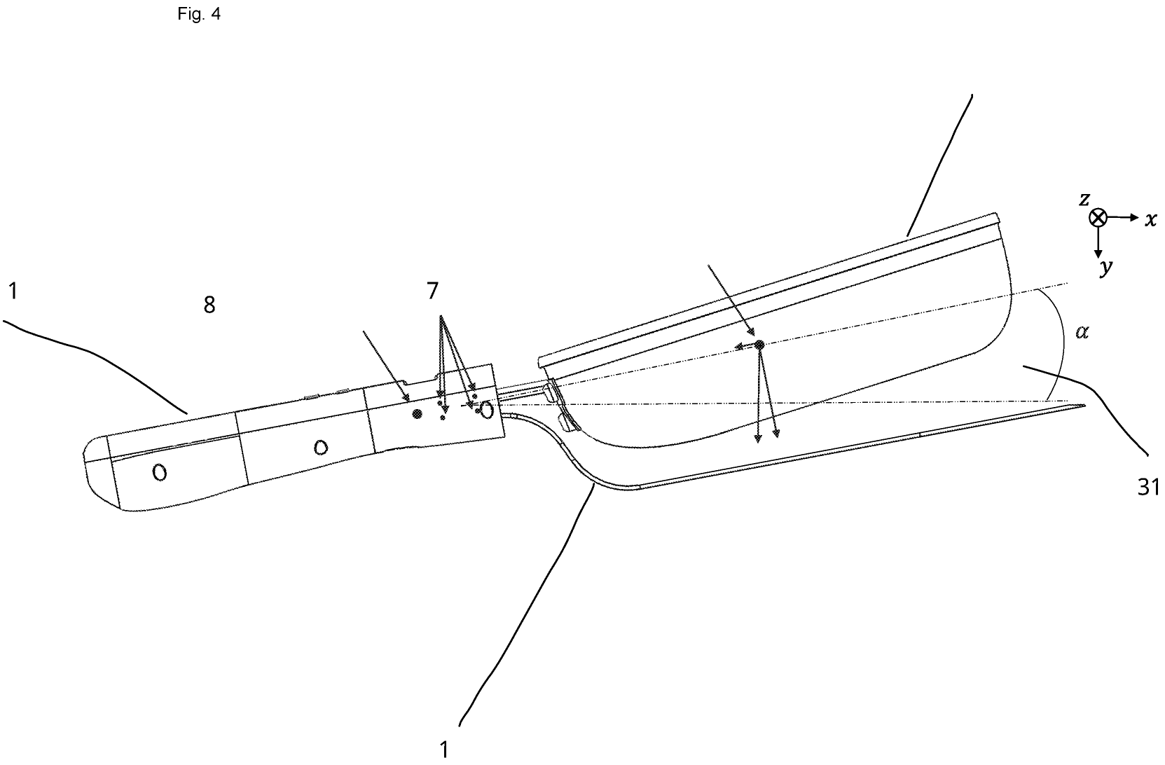

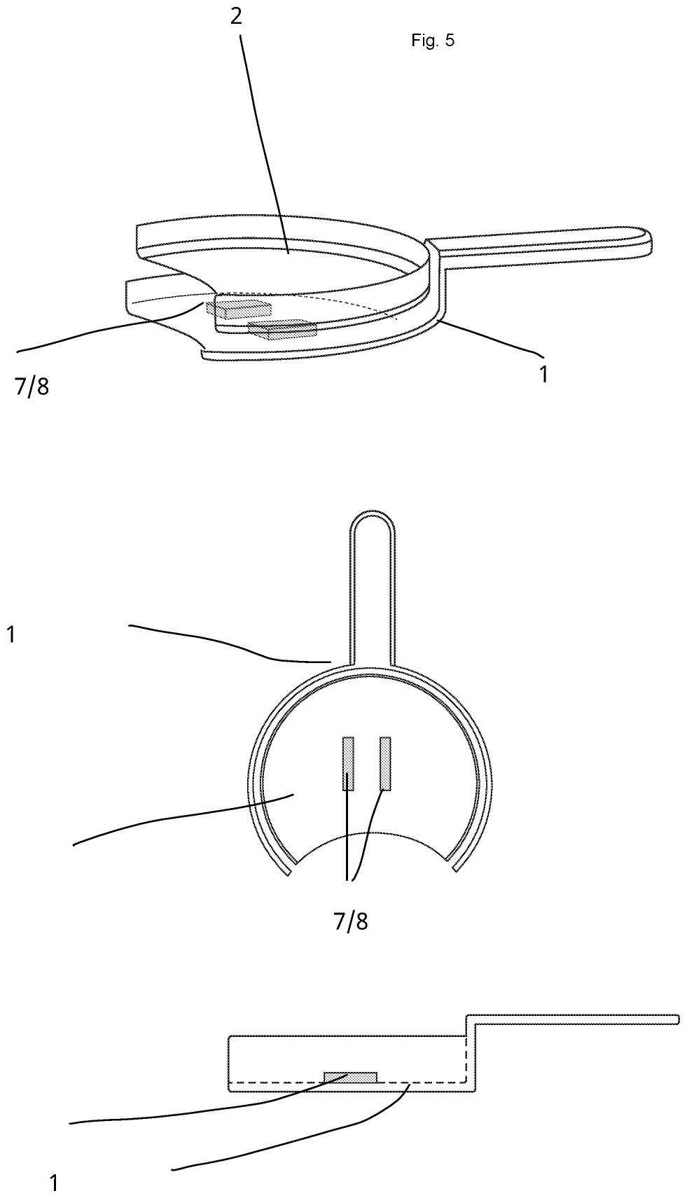

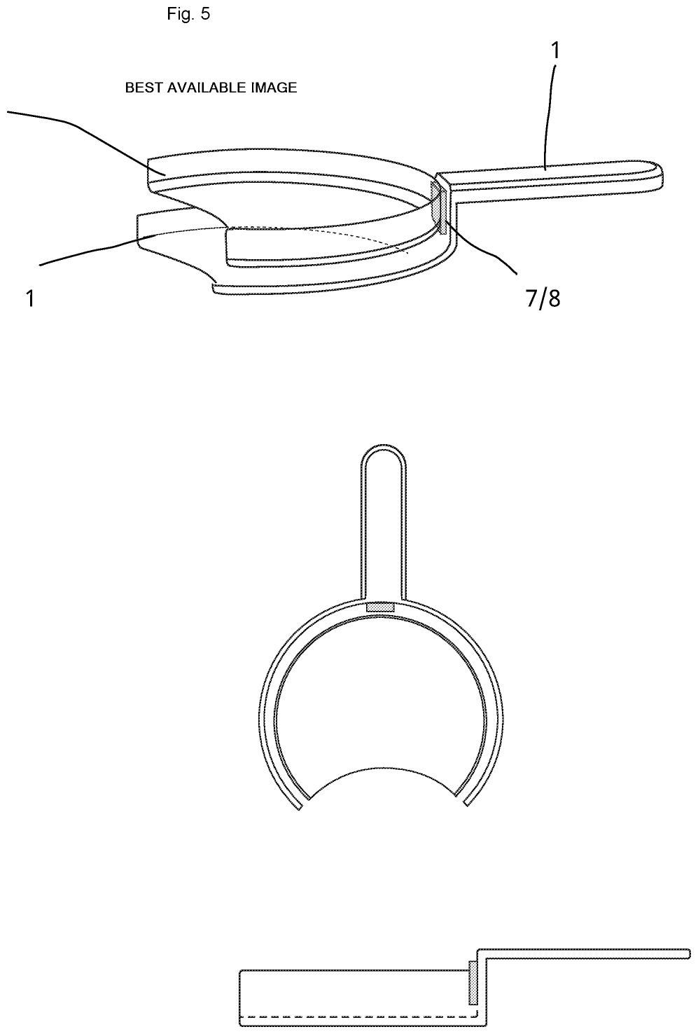

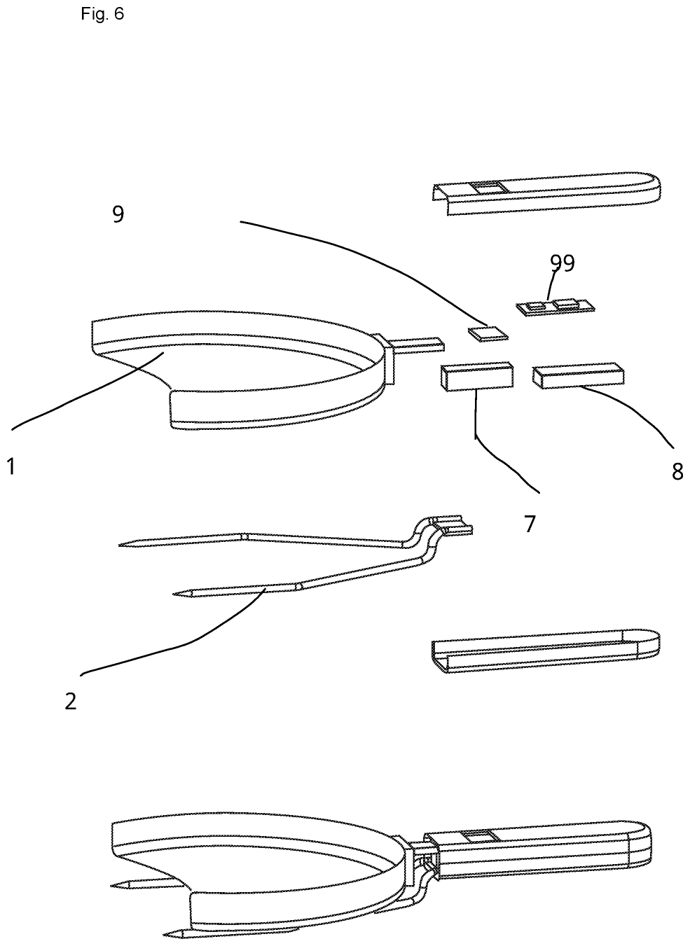

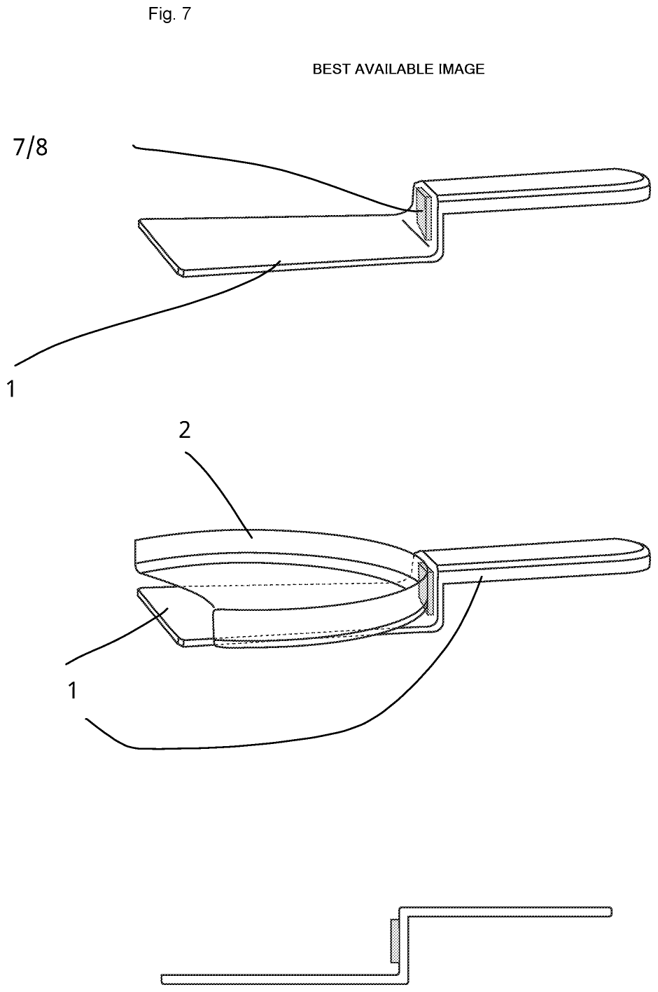

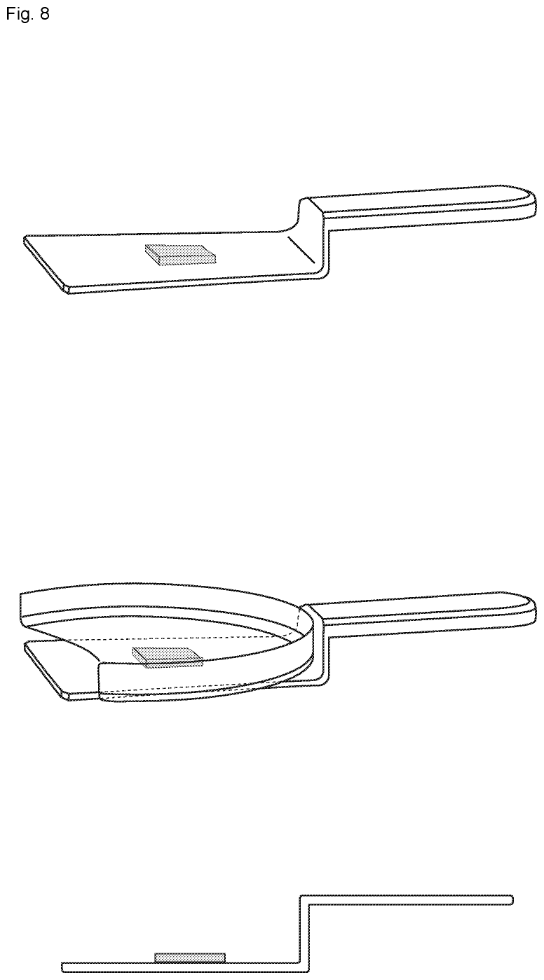

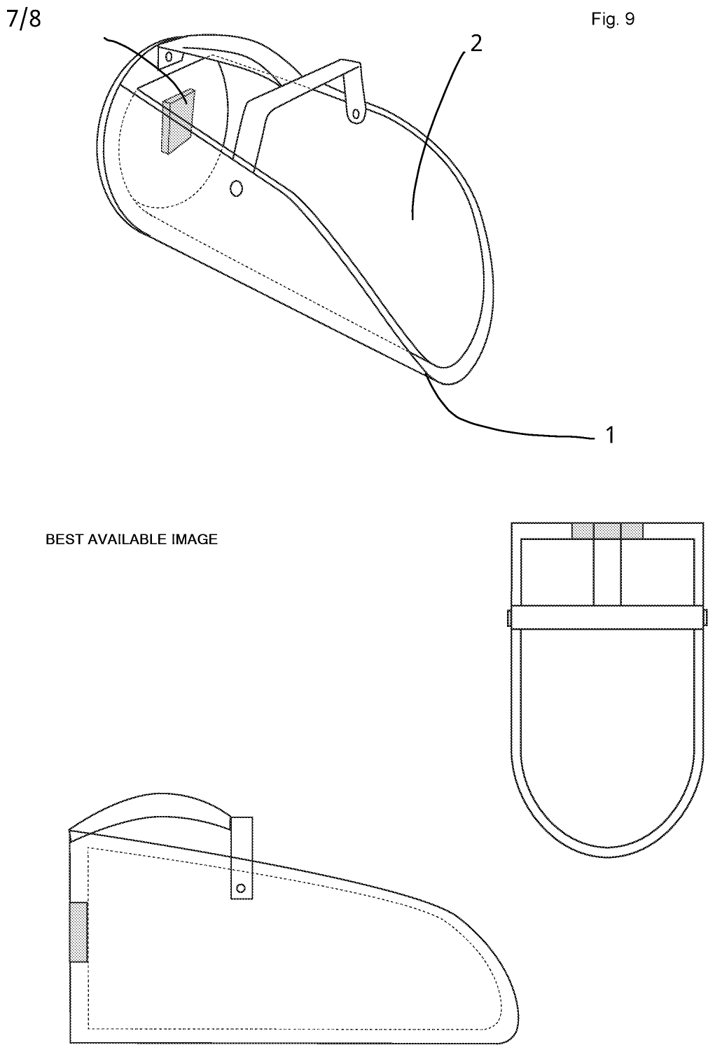

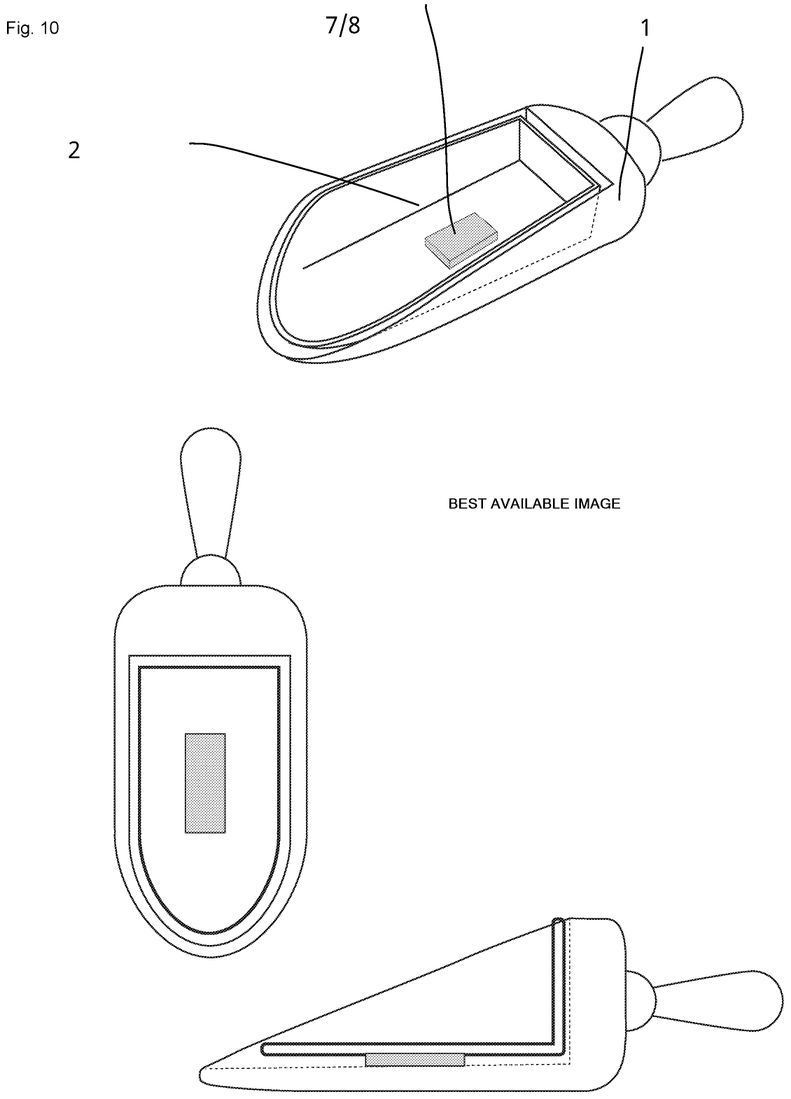

### DETAILED DESCRIPTION OF THE PROBLEM

To those who skilled in the art, it is apparent that an accurate measurement of materials is needed in many circumstances and fields. Such measurement is needed in trade and commerce for selling and buying certain goods, it is also needed it the art of manufacturing, pharma and chemical industries cooking and baking and many more actions.

Usually, the measurement is of weight, and it is especially needed when a certain amount of material is being taken or otherwise removed from a bulk a pile or other form of large quantity material.

Usually, such materials are collected by a tensile, be it a scoop, catcher, ladle, spatula or other.

The material could be collected from a container, a jar, a pile or a sack, and then either packed or being used by itself or with other ingredients or materials.

Usually when held in the vicinity of said pile or package the posture of the utensil is not leveled, thus its' orientation related to the ground varies.

While prior art teaches how to eliminate rapid movement of the utensil while repeatedly filing containers with a predetermined same quantity, there is a need in the art to enable the exact measurement of a material while it is in vicinity of the pile or bulk it was collected from, and to avoid the need of taking out the utensil, leveling up it's orientation and then weighing or reading its contents weight.

This need is not limited to indicating a predetermined portion, but rather to know what is the actual weight, in order to allow different uses or different quantities to be allowed with accordance to the material and the action it is needed for.

Leveling a weighing device is a fundamental requirement, that derives from the fact that the force we call weight Is force directed to the center of earth (i.e. is perpendicular to the ground) and follows the simple formula; force=mass×acceleration, where the acceleration is that of gravity which is approximately 9.7 meter (32 feet) per second. In order to measure weight accurately the weight mechanism, be it a spring a balance, a sensor such as a force motor type load cell, or any other, must have its weighing axis aligned with the gravitational field. Therefore the weighing pan or surface must be orthogonal (90 degrees) to the gravitational field. In ail directions and dimensions. If the surface of the weighing mechanism is not orthogonal to the weigh axis of the force motor, i.e. not leveled with the ground, the weight measured wouldn't be accurate.

When the weighing apparatus is combined with a utensil that is either handheld or put, in or on, a pile of material, the orientation is usually not leveled with the ground on two dimensions. The utensil could be tilt up or down and could be tilt left or right.

Each position or orientation reduces the output of the weighing mechanism in accordance with the angle it tilts.

The reduction in weight as the weighing surface deviates from the orthogonal axis to the ground, follows a cosine curve shape. If the angle of error is 0 degrees (perfect alignment) the cosine of 0 degrees=1.000 and there is no weight error. If the angle of error is 30° then the cosine=0.866, which is nearly 15% of force reduction. If the angular error is 45° then the cosine=0.707, which is nearly 30% of force reduction.

A tilt of a utensil, in such degrees, is quite frequent when it is inserted into a sack or a container, large or small, or when put next to a pile or skewer in order to load it. Furthermore, if said utensil is tilt on both dimensions or axis the reduction is exponential, i.e. if the utensil is 20° downwards which results in a reduction of over 6% (cos20°=0.939) and 20° to the left, then the reduction of the force is the product of (cos20°)2 or 0.94×0.94=0.88 which reflects 12% reduction of weight. If the tilt is 25° forward and 20° sidewards, the reduction is (cos25°)×(cos20°)=0.906×0.939=0.851 or 15%. If the tilt is 35° backward, and 25° sideward then the reduction in weight would be cos35°×cos25°=0.819×0.906=0.742, which is over 2.5% of force reduction.

Moreover, to ensure a quick and easy measurement, the handler of the utensil should be able to establish the accurate weight without the need of taking the utensil of the bulk, sack, skewer or pile and lift it in the air, by hand. Yet, all prior art weighing scoops require to hold the scoop in its handle and keep it in the air preventing it from touching anything.

### DETAILED DESCRIPTION OF THE EMBODIMENTS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

The present invention pertains to an inventive apparatus, allowing the accurate measurement of the content of a utensil. The apparatus being a smart utensil, is particularly useful for collecting material and determine the exact amount collected.

The present invention could be used, but not limited to, commodities, food, chemicals, industrial compounds and more.

In the food industry, the apparatus according to the present invention could be used for precooked ingredients, such as, but not limited to, sugar, flour, baking soda or other powders. It can be used for rice and other types of grains or legumes. It can also be used for cooked food served to plates or take-away bags, or for shawarma or doner kebab that is sliced from a turning skewer.

In the chemistry field, it can be used for the preparation of lab compounds and mixtures. It could be used for small scale constructing materials such as cement, gypsum, asphalt or other.

It is therefore understood to those skilled in the art that the present invention is of use for any material that can be collected manually with a utensil and should be of an exact quantity.

The content of said utensil could be collected from a pile, bulk, sack, box, barrel, container or being cut from skewer, chunk, block, wheel of cheese, or from jars, bottles or other boxes.

In an aspect of the present invention, the apparatus is a form of utensil and contains weighing means, orientation means (7), and a calculating module. Said utensil comprising also a content collecting member (2) and a touchable member.

The content collecting member (2) and the touchable member (1) are assembled in a manner that allows relative movement thereof and allows the weighing means (7) to be located in or close to both members joint or to perform as said joint.

The weighing means (7) is designed to measure the force applied by the content of the utensil towards the ground.

The weighing means (7) could be any sensor or weight measuring mechanism, having an output that reads an injective value representing the force applied on it by gravity.

The orientation means (7) could be any orientation sensor such as gyroscope, accelerometer, manometers or a combination thereof. It could be an attitude and heading reference system (AHRS) an Inertial Measurement Unit (IMU), or any other component designed to provide the output as set forth herein.

The orientation means (7) is designed to measure the orientation of the utensil with respect to the dimension orthogonal (leveled dimension) to earth gravity. Said orientation means (7) having an output of two values. The first value indicates the angle of the utensil with respect to the leveled dimension on an X-axis (up-down or forward-backward), and the second value indicates the angel of the utensil with respect to the leveled dimension on a Y-axis (left-right).

The calculating module (8) receives input from both weighing means, and orientation means (7) outputs. The calculating module (8) is designed to run a script that calculates the exact weight: of the content of the utensil by way of compensating for the weight reduction caused by any of the tilt angles, and by subtracting the tare weight of the utensils content collecting member (2).

Attention is drawn now to Fig. x, that depict the forces and the orientation of a utensil with accordance to the present invention. The utensil comprising a weighing means, orientation means (7), calculating module, a content collecting member (2) and a touchable member. Said utensil is tilted up by an angle of α°.

The weight of the content collecting member (2) is “Mccm·g”. The weight of the content collected on it is “Mcont·g”

The equivalent force of both forces “Mcont·g” and “Mccm·g” is the force “Mtotal·g” “α” is the pitch angle.

“β” is the roll angle. The only force measured by the weighing means (7) is of the total mass of the contents collecting member and the content collected, reduced by the cosine of the pitch angel multiplied by the cosine of the roll angel hence: M total·g×cosα×cos β=Weighing means (7) Output (WMO). The orientation means (7) output consist on two values ‘α’ and ‘β’.

The calculating module (8) receives an input comprising of WMO, ‘α’ and ‘β’. And perform a calculation to find the actual weight of the content collected, that is Mcont·g. At first it finds the gross weight of the content:

$$Mtotal \cdot g = \frac{W M O}{cos α \times cos β}$$

Next, the calculating module (8) subtracts the weight or the content collecting member (2) from the gross weight and get the weight of the content collected:

$$‘ Mtotal \cdot g ’ - ‘ Mccm \cdot g ’ = ‘ Mcont \cdot g ’$$

in some embodiments of the present invention, the output of both weighing and orientation means (7) are continuous while in others it is of a predetermined frequency.

In some embodiment, the output of the calculating module (8) is of the same frequency of its' input while in others it is of a lower frequency.

Optionally when the output of the calculating module (8) is less frequent than its' input, the calculating module (8) could be designed to compare, adjust or calculate an arithmetic mean of predefined numeral Mtotal·g outputs.

In an aspect of the present invention, it comprises means for reading the output of said calculating module, in a preferred embodiment of the present invention, the output means is a led or other screen (9) embedded into the touchable member (1) of the utensil, showing the numeral value of the weight (Mcont·g).

In other embodiment, the utensil could be designed to allow connectivity such as RF, IDRF, Bluetooth, Wi-Fi or any other, that allows the receipt of the calculating module (8) output in a detached screen or speaker.

Optionally in some embodiment of the present invention, a connectivity feature allows for connecting with other device and exchange data such as prices, level of total or partial stock and other values regarding the overall material collecting activities.

In some of the embodiment of the present invention at least one button (99) is attached to said calculating module. Said button could be assigned to any of said tasks: lock the reading of the calculated weight on the screen, balance the apparatus before use, choose a measurement system (metric, pounds etc.) or transmit data to or from the utensil.

Attention is drawn now to Figs. Y-z. In an aspect of the present invention, the touchable member (1) of the utensil is designed in a manner that allows to hold it, lay it on a surface leaning it on an object such as a chunk a skewer or a counter, or even having it inside a pile, a sack or other container.

The assembly of the content collecting member (2) and the touchable member (1) is designed to allow the free measured movement of the content collecting member (2) in relation to said touchable member (1) in a manner that eliminates the need for holding the utensil in the air and allows an accurate weight reading even when touched or laid as described.

It is therefore understood to those skilled in the art that the shape, design, and features of said touchable member (1) could vary and depends on different uses. In some embodiments of the present invention, the touchable member (1) consists of a handling part. Designed to be held by hand.

In other embodiments of the present invention, the touchable member (1) is located under the content collecting member (2), being of a full surface or of numeral stripes or rods.

In yet other embodiments of the present invention the touchable member (1) is designed to be under, or aside of the content collecting member (2) and longer towards the front, to allow the lean of the utensil against a wall, a counter or a skewer while cutting from it.

In more embodiments, the touchable member (1) is placed around and under the content collecting member (2), surrounding it and allows the accurate weighing while being touched both by the sides and the bottom, like when put in a pile a container or a sack.

It is therefore emphasized that both members can be of any suitable shape and role, as long as they allow touching one of them and a free weighing movement of the other.

In some embodiment of the present invention there could be numeral touchable members, (e.g. a handle and a bottom) Yet it is required that the assembly of the utensil would prevent any movement between said touchable members, by having them be made from one piece or have a solid joint.

1. A weight calculating utensil comprising:
a content collecting member (2) (CCM)
a touchable member
a weighing means
an orientation means (7)
a calculating module, wherein
said CCM is designed to contain a material, and wherein said touchable member (1) is designed to be in direct or in direct touch with the ground, and wherein
said weighing means (7) designed to measure and output the force applied by gravity of said CCM and said material, and wherein
said orientation means (7) designed to measure and output the angles of said utensil with regard of two axis parallel to the ground, and wherein
said calculating module (8) is designed to receive the output from said weighing means (7) and said orientation means (7), and to calculate the net weight of said material.

2. A weight calculating utensil according to claim 1, wherein said touchable member (1) is formed by a handle, a bottom, spikes, an envelope or any combination thereof.

3. A weight calculating utensil of claim 1, wherein said touchable member (1) is designed to be held by hand laid on a surface, lean on an object or any combination thereof.

4. A weight calculating utensil of claims 1-3, wherein the weighing means (7) is selected from a spring, a balance, a sensor, a force motor type load cell, a strain gouge, an accelerometer a vibrating wire, a capacitive load cell or any combination thereof.

5. A weight calculating utensil of claims 1-4, wherein said orientation means (7) is selected from a gyroscope, an accelerometer, a magnetomoeter or a combination thereof.

6. A weight calculating utensil of claims 1-5 to be used with bulk commodities.

7. A weight calculating utensil of claims 1-5, to be used to collect cut food.

8. A weight calculating utensil of claims 1-5, to be used with cooking and baking ingredients.

9. A weight calculating utensil of claims 1-5, to be used with chemical substances.

10. A weight calculating utensil of claims 1-5, to be used with constructing materials.

11. A weight calculating utensil of any pf previous claims, comprising at least one button, wherein said at least one button is assigned to: lock output, change system, balance, transmit or receive data or any combination thereof.
